(19) United States
(12) Patent Application Publication
(10) Pub. No.: US 2016/0182542 A1
(43) Pub. Date: Jun. 23, 2016

(54) DENIAL OF SERVICE AND OTHER RESOURCE EXHAUSTION DEFENSE AND MITIGATION USING TRANSITION TRACKING

(71) Applicant: Stuart STANIFORD, Freeville, NY (US)

(72) Inventor: Stuart STANIFORD, Freeville, NY (US)

(21) Appl. No.: 14/974,025

(22) Filed: Dec. 18, 2015

Related U.S. Application Data
(60) Provisional application No. 62/093,615, filed on Dec. 18, 2014.

(51) Int. Cl. H04L 29/06

(52) U.S. Cl. CPC H04L 63/1416

(57) ABSTRACT

Described is a method and system for determining a suspect in a resource exhaustion attack, for example DDoS (Distributed Denial of Service Attack), against a target processor using transitions between data processing requests. For example, a first website request followed by a second website request received from a remote sender at a server is determined to be statistically unusual transition and thus may raise suspicion about the remote sender. Such transitions for the remote sender can be cumulatively evaluated.

### CROSS-REFERENCE TO RELATED APPLICATION

The present non-provisional patent application claims the benefit of priority from U.S. Provisional Patent Application No. 62/093,615, filed Dec. 18, 2014, the entire contents of which are incorporated herein by reference.

### FIELD OF THE DISCLOSURE

The present disclosure relates to the field of protecting a computer or computer installation against an attack to exhaust a network resource, including a denial of service attack and a distributed denial of service attack, by determining a suspect based on pattern of resource requests.

### BACKGROUND OF THE DISCLOSURE

In recent years, distributed denial of service (DDoS) attacks have resulted in major financial loss. For example, a DDoS attack made by an attacker known as mafiaboy in February 2000 targeted major sites, such as Yahoo, Amazon, Fifa, E-TRADE, Ebay and CNN. The estimated cost of the DDoS attack was in the hundreds of millions of dollars. In Spring 2012, some of the largest banks in the U.S. were attacked, each bank being hit with 20 gigabytes per second of traffic, which increased to 40 gigabytes, to 80 gigabytes and ultimately to 100 gigabytes per second. HTTP requests were sent to flood the server installations of the target banks. Several major bank websites experienced outages of many hours because of the attacks.

Intrusion detection systems (IDS) and Intrusion prevention systems (IPS) have been used for DoS and DDoS attacks. For example, systems are known that look for the identity of the sender or sender signature or that of a sender device's identity.

Firewalls typically are designed to detect and protect against certain forms of malware, such as worms, viruses or trojan horses. A firewall typically cannot distinguish between legitimate network traffic and network traffic meant to exhaust a network resource, such as a denial of service (DoS) attack or Distributed Denial of Service (DDoS) attack.

In a DDoS attack, a network resource or a network installation including one or more websites in a server rack, is flooded with network traffic that can include requests for data from the network resource.

A DDoS attack may use a central source to propagate malicious code, which is then distributed to other servers and/or clients, for example using a protocol such as Hypertext Transfer Protocol (HTTP), File Transfer Protocol (FTP) and Remote Procedure Call (RPC). The compromised servers and/or clients form a distributed, loosely controlled set of “zombies” (sometimes known as bots) that will participate in the attack against a target resource or victim. Servers typically have privileged and high bandwidth Internet access, while clients often work through Internet Service Providers from readily identifiable IP address blocks. Typically, the target resource's operational bandwidth will be exhausted when the attacker floods the target resource with a greater amount of data than the network provides, or in more sophisticated attacks, a greater number of requests for data or processing than the available request processing capacity available for the target resource.

The impact on the target resource can be either disruptive and render the target resource unavailable during or after the attack, or may seriously degrade the target resource. A degrading attack can consume victim resources over a period of time, causing significant diminution or delay of the target resource's ability to respond or to provide services, or to cause the target exorbitant costs for billed server resources.

A reflector, such as a DNS (domain name service) server, can be created by a bot that sends a request. For example, a DNS server may answer a request in which the sender information of the packet contains a forged address of the target network resource. In this way, when the reflector responds to the request, the reply is sent to the target resource.

According to some DDoS mitigation solutions, traffic is redirected to the company's DDoS mitigation service, and only legitimate traffic is sent to the client site. Such providers can provide a filter to scrub network traffic received by the client resource installation to try to identify a source for the attack. However, in many complex attacks, a human being has to make a decision whether to shut down requests from the suspected source. Such a decision carries risks for the organization and for the individual making the decision. For example, shutting down requests from a suspected source based on false positives can deny the network resource from an important customer or client of the organization. On the other hand, failing to shut down requests from a suspected source of the request can result in failure to stop the DDoS attack and continue impairment or exhaustion of the network resource.

Other prior art systems tend to identify the signature of the remote sender or source to filter out an attack. Various providers offer services that attempt to analyze requests received from a remote sender to attempt to determine a suspect in a DDoS attack. As discussed, the source may be difficult to identify and often there may be more than one source.

See the content of, U.S. Pat. Nos. 6,633,835; 6,801,940; 6,907,525; 7,069,588; 7,096,498; 7,107,619; 7,171,683; 7,213,260; 7,225,466; 7,234,168; 7,299,277; 7,308,715; 7,313,815; 7,331,060; 7,356,596; 7,389,537; 7,409,714; 7,415,018; 7,463,590; 7,478,168; 7,478,429; 7,508,764; 7,515,926; 7,536,552; 7,568,224; 7,574,740; 7,584,507; 7,590,728; 7,594,009; 7,607,170; 7,624,444; 7,624,447; 7,653,938; 7,653,942; 7,681,235; 7,693,947; 7,694,128; 7,707,287; 7,707,305; 7,733,891; 7,738,396; 7,823,204; 7,836,496; 7,843,914; 7,869,352; 7,921,460; 7,933,985; 7,944,844; 7,979,368; 7,979,694; 7,984,493; 7,987,503; 8,000,329; 8,010,469; 8,019,866; 8,031,627; 8,042,149; 8,042,181; 8,060,607; 8,065,725; 8,069,481; 8,089,895; 8,135,657; 8,141,148; 8,151,348; 8,161,540; 8,185,651; 8,204,082; 8,295,188; 8,331,369; 8,353,003; 8,370,407; 8,370,937; 8,375,435; 8,380,870; 8,392,699; 8,392,991; 8,402,540; 8,407,342; 8,407,785; 8,423,645; 8,433,792; 8,438,241; 8,438,639; 8,468,589; 8,468,590; 8,484,372; 8,510,826; 8,533,819; 8,543,693; 8,554,948; 8,561,187; 8,561,189; 8,566,928; 8,566,936; 8,576,881; 8,578,497; 8,582,567; 8,601,322; 8,601,565; 8,631,495; 8,654,668; 8,670,316; 8,677,489; 8,677,505; 8,687,638; 8,694,833; 8,706,914; 8,706,915; 8,706,921; 8,726,379; 8,762,188; 8,769,665; 8,773,852; 8,782,783; 8,789,173; 8,806,009; 8,811,401; 8,819,808; 8,819,821; 8,824,508; 8,848,741; 8,856,600; and U.S. Patent Application Publication Numbers: 20020083175; 20020166063; 20030004688; 20030004689; 20030009699; 20030014662; 20030037258; 20030046577; 20030046581; 20030070096; 20030110274; 20030110288; 20030159070; 20030172145; 20030172167; 20030172292; 20030172294; 20030182423; 20030188189; 20040034794; 20040054925; 20040059944; 20040114519; 20040117478; 20040229199; 20040250124; 20040250158; 20040257999; 20050018618; 20050021999; 20050044352; 20050058129; 20050105513; 20050120090; 20050120242; 20050125195; 20050166049; 20050204169; 20050278779; 20060036727; 20060069912; 20060074621; 20060075084; 20060075480; 20060075491; 20060092861; 20060107318; 20060117386; 20060137009; 20060174341; 20060212572; 20060229022; 20060230450; 20060253447; 20060265747; 20060267802; 20060272018; 20070022474; 20070022479; 20070033645; 20070038755; 20070076853; 20070121596; 20070124801; 20070130619; 20070180522; 20070192863; 20070192867; 20070234414; 20070291739; 20070300286; 20070300298; 20080047016; 20080052774; 20080077995; 20080133517; 20080133518; 20080134330; 20080162390; 20080201413; 20080222734; 20080229415; 20080240128; 20080262990; 20080262991; 20080263661; 20080295175; 20080313704; 20090003225; 20090003349; 20090003364; 20090003375; 20090013404; 20090028135; 20090037592; 20090144806; 20090191608; 20090216910; 20090262741; 20090281864; 20090300177; 20100091676; 20100103837; 20100154057; 20100162350; 20100165862; 20100191850; 20100205014; 20100212005; 20100226369; 20100251370; 20110019547; 20110035469; 20110066716; 20110066724; 20110071997; 20110078782; 20110099622; 20110107412; 20110126196; 20110131406; 20110173697; 20110197274; 20110213869; 20110214157; 20110219035; 20110219445; 20110231510; 20110231564; 20110238855; 20110299419; 20120005287; 20120017262; 20120084858; 20120129517; 20120159623; 20120173609; 20120204261; 20120204264; 20120204265; 20120216282; 20120218901; 20120227088; 20120232679; 20120240185; 20120272206; 20120284516; 20120324572; 20130007870; 20130007882; 20130054816; 20130055388; 20130085914; 20130124712; 20130133072; 20130139214; 20130145464; 20130152187; 20130185056; 20130198065; 20130198805; 20130212679; 20130215754; 20130219495; 20130219502; 20130223438; 20130235870; 20130238885; 20130242983; 20130263247; 20130276090; 20130291107; 20130298184; 20130306276; 20130340977; 20130342989; 20130342993; 20130343181; 20130343207; 20130343377; 20130343378; 20130343379; 20130343380; 20130343387; 20130343388; 20130343389; 20130343390; 20130343407; 20130343408; 20130346415; 20130346628; 20130346637; 20130346639; 20130346667; 20130346700; 20130346719; 20130346736; 20130346756; 20130346814; 20130346987; 20130347103; 20130347116; 20140026215; 20140033310; 20140059641; 20140089506; 20140098662; 20140150100; 20140157370; 20140157405; 20140173731; 20140181968; 20140215621; 20140269728; 20140282887; each of which is expressly incorporated herein by reference in its entirety.

### BRIEF DESCRIPTION OF THE DRAWINGS

FIG. 1 is an illustration of an example of an overview of components of a suspect determination engine according to an aspect of the present disclosure.

FIG. 2 is an illustration of an example of an overview of a data center including the suspect determination engine according to an aspect of the present disclosure.

FIGS. 3A-3B illustrate a process of determining a suspect in a resource exhaustion attack according to an aspect of the present disclosure.

FIG. 4 illustrates a process of learning normal “human”-driven transition behavior and of generating an anomaly representations matrix according to an aspect of the present disclosure.

FIG. 5 illustrates a process of threshold throttling according to an aspect of the present disclosure.

### DETAILED DESCRIPTION OF THE EMBODIMENTS

According to an aspect of the disclosure, communication sessions comprising transaction processing requests, such as a request for a webpage from a webserver, are tracked. A transition between a first data request from a sender and a second data request from the sender is assigned an anomaly representation, such as a value that represents a probability of the sequence of data requests, according to a transition anomaly value matrix earlier generated. The transition need not be between two simple states, but rather the transition is the new state based on the sequence of actions leading to the immediately prior state. For example, during a learning mode, normal web traffic to a site may be monitored and analyzed, such that the probability of each transition between data requests is assigned a probability value. In addition, data packets may be analyzed for additional suspect features, such as an overlapping range of byte counters in a series of packets. An anomaly representation may be assigned for the sender based on a detection of such packets, and this anomaly representation may be combined with the anomaly representation assigned for the transition. Then, based on a cumulative anomaly profile for the remote sender or source of the data requests, based on a combination of the anomaly representations of the preceding and current transitions, the remote sender can be identified as a probable suspect and appropriate action, such as instructing a cessation of responding to the remote sender's requests, can be initiated. In some cases, multiple remote senders show similar anomaly representations. This is a very good indicator of a botnet. These remote senders can be aggregated and the collective anomaly representations could be analyzed for more evident attack. In some cases, anomalous communications are observed, but these do not appear to be, or be part of, an impending threat or significant cost in terms of consumed resources. In those cases, the communication session may be permitted to continue uninterrupted, e.g., with careful analysis and logging of the behavior. This anomalous behavior trigger may be forwarded to other security servers within the infrastructure, in case the behavior is malicious but not part of a DDoS attack. Of course, the system and method according to the present technology may provide behavioral analysis of web traffic for a variety of purposes, only one of which is DDoS detection.

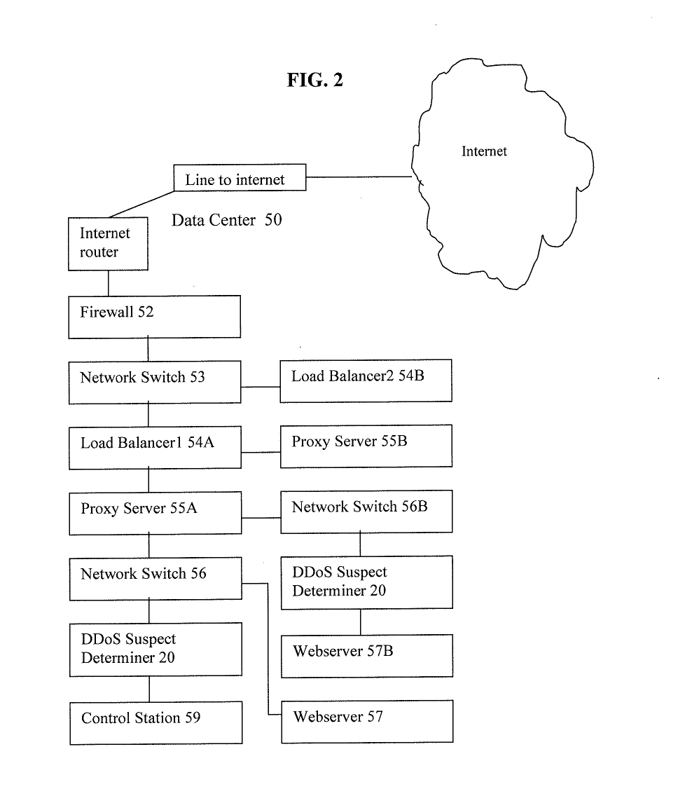

A typical data center for a large website installation, such as that of a major bank, may be a computer cluster or set of racks which provide network services to hundreds of client requests per second. For example, as illustrated in FIG. 2, one or more OC-3 or OC-12, OC-24, OC-48, OC-192, or other types of high speed lines now known or later developed or other types of connection to a data network, such as the Internet, may deliver and/or receive 40 gigabytes per second or more of network traffic data.

Typically, one or more firewall devices 52 will be positioned to monitor incoming network traffic based on applied rule sets. In this way, the firewall device establishes a barrier, for example by monitoring incoming network data for malicious activity, such as generated by known or unknown Trojan horses, worms, viruses and the like. The firewall may detect the data at the application level of the OSI model.

In addition to the firewall, a network switch 53 may be positioned to connect devices together on the computer network by forwarding data to one or more destination devices. Typically, the destination device's Media Access Control (MAC) address is used to forward the data. Often, the network switch is positioned after the firewall. One or more load balancer (54A, 54B) may be positioned to distribute the traffic load to a number of devices. One or more proxy servers, and additional network switches 56 may also be provided. Devices connected to load balancer 54B and to proxy server 55B are not illustrated in FIG. 2 for the sake of clarity and brevity. The web server(s) is typically located behind these devices, and perhaps additional firewalls. In this context, “located behind” a first device refers to the logical positioning or communicative positioning of the devices, not necessarily to the physical positioning of the devices on the rack or set of racks. Also illustrated in FIG. 2 is a deployment of DDoS suspect determiner 20 inline, that is, before webserver 57B. Another network switch, illustrated in FIG. 2 as network switch 56B, may be connected to proxy server 55A, and DDoS suspect determiner 20 may be behind it. One or more webservers, by way of example illustrated as webserver 57B, may be located behind or hanged off of this DDos suspect determiner 20. It will be understood that one or both of such DDos suspect determiners may be deployed, or more than two such DDoS suspect determiners may be positioned in a data center. In addition, one DDoS suspect determiner 20, for example, the one positioned off to a side, as shown on the left side of FIG. 2, may be set in an monitoring mode, for example, in a testing or evaluation phase of DDoS suspect determiner 20, while the second one, for example, the DDOS suspect determiner in front of webserver 57B, may be used in the active/defense mode.

Additional devices (not illustrated in FIG. 2) may also be provided on the rack, as would be readily understood. For example, a database system, such as a SQL or NoSQL database system, for example Cassandra, may be provided to respond to queries generated by or passed through the web server(s). Thus, one or more databases and additional firewalls may be positioned behind the web servers. In addition, many other “blades” and other hardware, such as network attached storage devices and backup storage devices and other peripheral devices may also be connected to otherwise provided on the rack. It will be understood that the rack configuration is discussed and provided by way of illustrative example, however many other configurations and more than one of such devices may be provided on the rack. A cloud-based architecture is also contemplated, according to which suspect determination engine 20 is located off site in the cloud, for example, at third-party vendor premises, and incoming packets or a copy of incoming packets are transmitted by the data center thereto. Also contemplated is a virtual machine or virtual appliance implementation, provided in the cloud, as discussed, or provided at the data center premises to be defended. In such an implementation, one or more existing devices, for example, server computers or other computers, run software that provides an instance of, or provides the functionality described for, DDoS suspect determination engine 20.

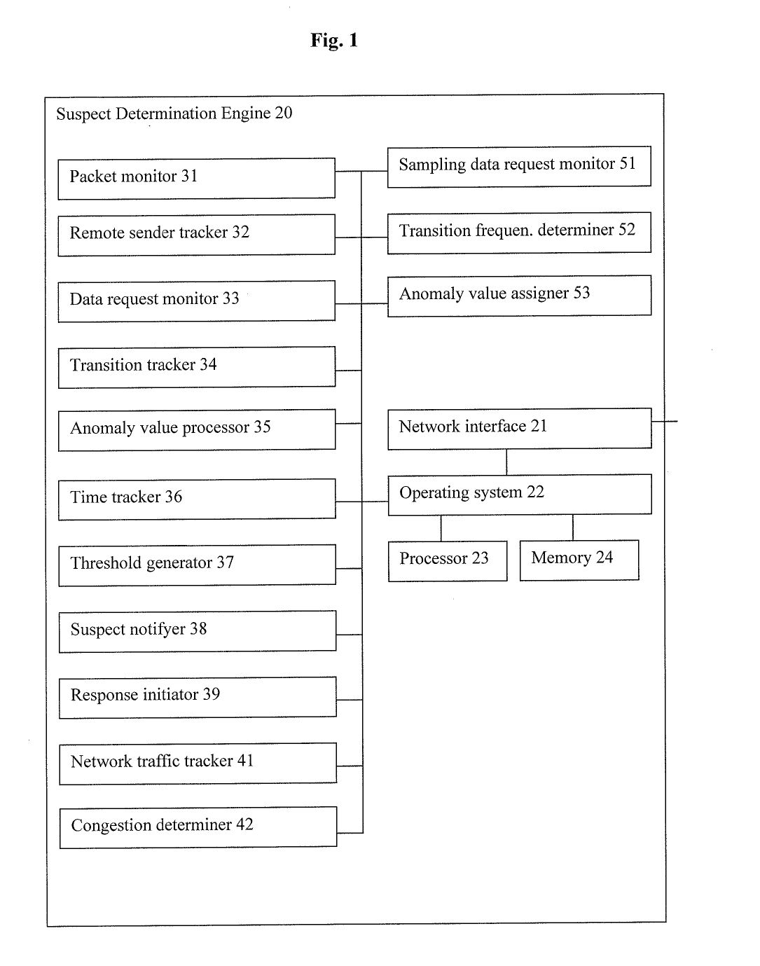

FIG. 1 illustrates suspect determination engine 20, which includes a network interface 21 that may receive data from a switch or SPAN port that provides port mirroring for the suspect determination engine 20. For example, suspect determination engine 20 may be provided as a separate device or “blade” on a rack and may receive from a network switch the same data stream provided to the web server device, or may act as a filter with the data stream passing through the device. The data stream may be decoded at this stage. That is, in order to assess probability of malicious behavior by way of an anomaly score, packet content inspection is required. In the alternative, suspect determination engine 20 may be integrated into one or more devices of the data center. Suspect determination engine may be implemented as software, hardware, firmware or as a combination of the foregoing.

According to an aspect of the disclosure, suspect determination engine 20 may be positioned just before the webpage server as one or more devices. However, it will be understood that other configurations are also possible. Suspect determination engine 20 may be provided as part of more than one device on a rack, or may be provided as a software or hardware module, or a combination of software or hardware modules on a device with other functions. One such suspect determination engine 20 may be provided at each webserver 57. Because in some cases the behavior may only emerge as being anomalous over a series of packets and their contained requests, the engine may analyze the network traffic before it is distributed to distributed servers, since in a large data center, a series of requests from a single source may be handled by multiple servers over a course of time, due in part to the load balancer. This would particularly be the case if anomalous behavior consumes resources of a first server, making it unavailable for subsequent processing of requests, such that the load balancer would target subsequent requests to another server.

The at least one load balancer may be programmed to send all requests from a respective remote sender or source to only one web server. This requires, of course, that the load balancer maintain a profile for each communication session or remote sender. In this way, each suspect determination engine 20 will “see” all data requests from a single remote sender, at least in any given session or period of time. The anomaly score assigned to the remote sender will therefore be based on data from all data requests of the respective remote sender. Accordingly, suspect determination engine 20 may receive a copy of all or virtually all network packets received by the webserver from a given remote sender.

The present technology encompasses a system and method for monitoring a stream of Internet traffic from a plurality of sources, to determine malicious behavior, especially at a firewall of a data center hosting web servers. Each packet or group of packets comprising a communication stream may be analyzed for anomalous behavior by tracking actions and sequences of actions and comparing these to profiles of typical users, especially under normal circumstances. Behavior expressed within a communication stream that is statistically similar to various types of normal behavior is allowed to pass, and may be used to adaptively update the “normal” statistics. In order to track communication streams over time, an anomaly accumulator may be provided, which provides one or more scalar values which indicate a risk that a respective stream represents anomalous actionable behavior or malicious behavior. The accumulator may be time or action weighted, so that activities which are rare, but not indicative of an attempt to consume limited resources, do not result in a false positive. On the other hand, if a series of activities represented in a communication stream are rare within the set of normal communication streams, and include actions that appear intended to consume limited resources, and especially if multiple previously rare actions are observed concurrently, the system may block those communication streams from consuming those resources. In some cases, a variety of defensive actions may be employed. For example, in high risk situations, the IP address from which the attack emanates may be blocked, and the actions or sequences of actions characteristic of the attack coded as a high risk of anomalous behavior for other communication streams. In moderate risk situations, the processing of the communication stream may be throttled, such that sufficiently few transactions of the anomalous resource consuming type are processed within each interval, so that the resource is conserved for other users. In low risk situations, the communication stream may continue uninterrupted, with continued monitoring of the communication stream for further anomalous behavior.

Therefore, one aspect of the technology comprises concurrently monitoring a plurality of interactive communication sessions each over a series of communication exchanges, to characterize each respective interactive communication session with respect to one or more statistical anomaly parameters, wherein the characterization relates to probability of coordinate malicious or abnormal resource consumption behavior. The characterization is preferably cumulative, with a decay. As the negative log of the cumulative characterization exceeds a threshold, which may be static or adaptive, defensive actions may be triggered.

In a learning mode, sampling data request monitor 51 monitors data requests received from each remote sender. A sequence of two data requests from the remote sender is interpreted as a “transition.” Transition tracker 34 can identify such sequences of data requests, such as webpage requests from a sender.

Pages may request information even when a human user is not requesting information. There may be automatic transitions, for example, image tags can be downloaded, iframe tags, JAVASCRIPT can be rendered, and the like. In addition, proxies can cache images, such as a company logo, as an image tag. Thus, such data may not be requested and may not be counted (i.e., ignored) as a “transition,” depending on the prior state of the rendered page. This filtering helps to identify user “actions”, and permit scoring of such actions with respect to anomalous behavior.

Accordingly, transition tracker 34 may keep track of the referer header information. Thus, JAVASCRIPT, or a logo image information can be filtered out because such objects do not refer to some other object. Thus, a transition may only be interpreted as such if the data request sequence includes a change according to the internal referer headers of the most recent requests.

A frequency of each transition is determined by transition frequency determiner 52. More common transitions (during normal traffic periods) may be assigned a low anomaly representation, such as a numerical value, a percentage, a value on a scale from zero to one, or some other representation of anomaly for the transition. Anomaly representations for transitions may be stored in a transitory anomaly matrix as logarithmic values and thus the anomaly representation may be combined on a logarithmic scale to arrive at a total running anomaly score or anomaly profile for the remote sender or source. Less frequent transitions are assigned a higher anomaly representation. An example of a common transition may be a request for an “About Us” page from the homepage of a site. An example of a less common transition, but not necessarily a rare transition, may be a request for “Privacy Policy” from the homepage. A rare transition, and therefore one that earns a higher anomaly value, may be a request for an obscure page to which there is no link at all from the previous page. Also, transition timings may be kept track of. For example, requesting pages within milliseconds or some other very short intervals may be a warning sign that the requests are generated by a bot. Repeated sequential requests for the same page may also be treated as more suspect.

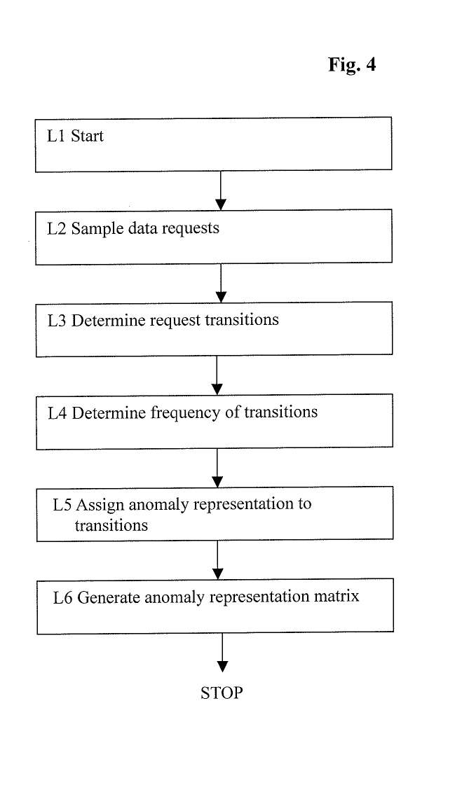

A machine learning mode as illustrated in FIG. 4. After the suspect determination engine 20 or components thereof are deployed, learning may start at L1 of FIG. 4. At L2, all or some of data requests or other network traffic from the remote sender may be sampled and sequences or transitions between the data requests from the remote sender may be determined at L3. At L4, based on the frequency of transitions, anomaly representations are assigned to generate a lookup table or transition anomaly representation matrix at L6. This machine learning may be continued for a period of time, for a pre-defined number of data requests or preset number of transitions, for a preset number of remote senders, or until the learning is stopped. A fully adaptive system is also possible, which continually learns. However, upon detection of a possible attack, or if a source appears to be acting anomalously, learning mode may be quickly suspended and the defense mode may be deployed. Typically, the system detects anomalies by detecting rare patterns of transitions, which may in the aggregate increase over historical averages. The system therefore is sensitive to rare transitions. It does not necessarily analyze the rare transitions to determine the nature of a threat, though for a small portion of network traffic, the suspect communication sessions may be forwarded to an instrumented server to determine the nature of the potential threat. In some cases, it is also possible to produce a statistical analysis of a positive correlation with malicious behavior, such that the rarity of the behavior is not per se the trigger, but rather the similarity to previously identified malicious behavior. Such a system is not necessarily responsive to emerging threats, but can be used to abate previously known threats.

Based on these anomaly values, in a deployed DDoS protection mode, suspect determination engine 20 or components thereof may monitor traffic to determine a resource exhaustion attack. Data request monitor 33 monitors each data request, such as a webpage request from a remote sender, and transition tracker 34 determines when a transition between two data requests has taken place. Transition tracker 34 also retrieves from the transition matrix anomaly values for each respective transition.

Anomaly value processor 35 then assigns a running anomaly profile to the remote sender, which is kept track of by the remote sender traffic 32. For example, transition anomaly values for the remote sender can be added and a running anomaly value for the remote user can thus be tabulated. When the anomaly value tabulated for the remote sender meets or exceeds a given anomaly value threshold, then remote sender can be identified as a suspect.

If the remote sender does not exceed the threshold anomaly value within a certain period of time, for example, ten seconds, five seconds, 30 seconds, two hours or from learned models specific for the resource under test, for example, five times the average gap hit for the URL, or within some other time interval then the anomaly profile for the remote sender can be reset to zero or decay. The accumulation may also be based on a number of transitions. Time tracker 36 can keep track of the first transition detected for the remote sender and when the period of time expires, can send a signal to reset the anomaly value tabulated for the remote sender, unless the remote sender has reached the actionable threshold value within the period of time. A gradual decay for a total anomaly value for a sender is also contemplated. An example of such a gradual decay implementation is as follows: a time may be tracked since the occurrence of the previous transition with a statistically significant transition value. A transition with an assigned anomaly value lower than a threshold of statistical significance may be ignored and not used in the total anomaly score of the sender for purposes of such an implementation, but in any case the timing of such a prior statistically insignificant transition may be ignored by such an implementation. The total anomaly value for the sender is then decayed according to how much time has occurred since the previous significant transition. The longer the time that has elapsed, the more the total anomaly score for the sender can be decayed. If less than a threshold amount of time has elapsed since the most recent statistically significant transition, then there may be no decay calculated at all in the total anomaly value for the sender. In this way, the system needs to be keep track only of the time elapsed since the most recent statistically significant transition and the total anomaly value for the sender when processing the anomaly value of the current transition for each sender. The timing of a transition may be calculated based on a time of the receipt of a request for the webpage.

Action may be taken when the suspect remote sender is identified. For example, the action may to send a signal to a control station 59 illustrated in FIG. 2, which may be notified to a human operator, shutting down the remote sender's packets received by webserver 57 that is receiving this remote sender's data traffic, alerting authorities or other actions.

However, according to an aspect of the disclosure, no action is taken unless network congestion, resource exhaustion or substantial resource exhaustion is detected, for example, by network switch 56, by webserver 57, by an earlier positioned network interface, or by a combination of the foregoing. Such network congestion or resource exhaustion or substantial resource exhaustion may evidence an ongoing DDoS or other resource exhaustion attack. In this way, the risk of acting based on false positives may be mitigated.

Network traffic tracker 41 can track a level of current network traffic. For example, network traffic tracker 41 may monitor a number of gigabits of data currently being received or sent by the website installation or a component thereof. Congestion determiner 42 may signal the existence of network congestion when a certain level of network traffic exists, when server utilization normalized for time of day, day or week and holidays is outside of normal bounds, based on a high CPU utilization of one or more device at data center 50, when heat detected at one or more devices of data center 50 exceeds a preset temperature, or the like. For example, congestion determiner 42 may signal the existence of congestion when the traffic is at or near the maximum bandwidth capacity of the installation. For example, if the installation can handle 40 gigabits per second of incoming network traffic, then congestion may be determined when traffic reaches 80% or more of the maximum or 97% or more of the maximum or the like, or when such network traffic levels prevail for longer than a previously set time, such as three seconds, five seconds, seven seconds or the like. Also, network congestion tracker 41 in determining whether congestion exists may keep track of how long it takes webservers to respond to requests compared to standard response times that they learn in a learning mode or obtain elsewhere. Another metric is what percentage of requests are servers able to respond to successfully. If they are not responding to nearly all of them then it is evidence of network congestion.

Once congestion is determined, one or more actions may be taken when the tabulated or otherwise computer anomaly profile for remote sender exceeds or meets the threshold set by threshold generator 37.

Threshold generator 37 can provide a dynamic threshold that is throttled. For example, a remote sender or source with the highest anomaly score or profile may be filtered or blocked, and a threshold may be adjusted down to filter out the next highest anomaly profile remote sender until the system is no longer under attack. The system can monitor whether response time has improved and if it has not, then dynamic thresholding may be continued to adjust down the threshold.

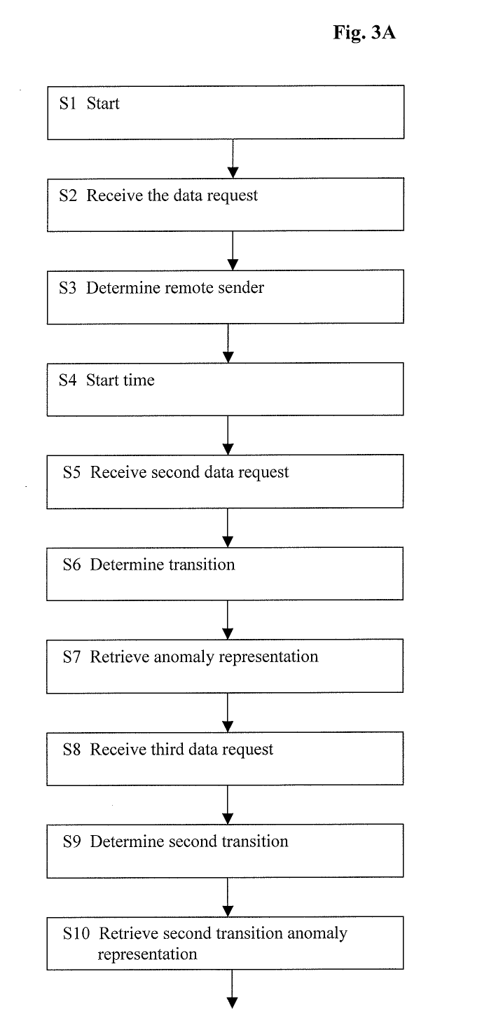

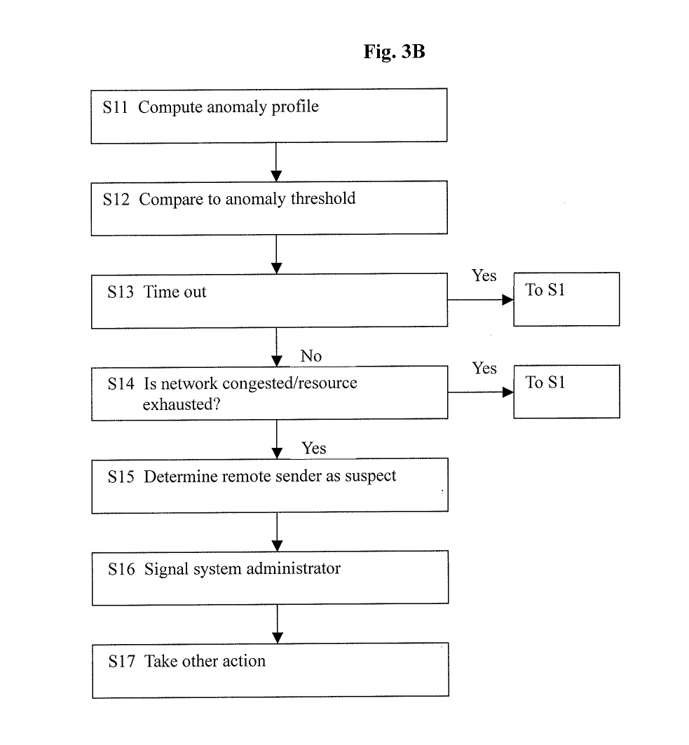

An example of a DDoS protection deployment mode will now be described with reference to FIGS. 3A-3B.

After the suspect determination engine 20 is deployed and started at S1, a data request is received at S2 and the remote sender is determined at S3. At this time, a clock at S4 may be started to keep track of the time of the first data request from the remote sender. Alternatively, a clock may be started when the first transition between the first data request and the second data request from this remote sender is determined or at some other such time. At S5, a second data request is received from the remote sender, and a first transition is determined at S6. At S7, an anomaly representation for this first transition is retrieved from the transition anomaly representation matrix or lookup table or the like previously generated in the transition anomaly learning mode. Hash tables may be used to keep track of transition anomaly scores and timings. A source-URL key may be used for a hash table that stores the time of (or since) the most recent request by a source/sender for a URL. As discussed, according to one implementation, only the timing of transitions with statistically significant anomaly scores (or transitions with an anomaly scores higher than a threshold) need be stored. A URL-URL key may be used for a hash table that stores anomaly values for transitions between URL requests. Memory pruning techniques may be used on a regular basis or near constantly as a background process to delete information in tables with the least utility or relevance.

At S8, a third data request is received and a second transition between the second data request and the third data request is determined at S9. At S10, the second transition anomaly representation is retrieved for the second transition from the transition anomaly representation matrix. At S11, an anomaly profile for the remote sender or source of the data traffic is tabulated or otherwise computed derived at an anomaly profile for the remote sender.

At S12, the anomaly profile is compared with an anomaly threshold previously set. If the time from the time clock started at the time of the receipt of the first data request or the determination of the first transition or the assigning of the first anomaly representation or at some other such relevant time until the comparison with the anomaly threshold or until the retrieval of the second or most recent anomaly representation has not expired, then at S14, it is determined whether the network is congested or the resource is exhausted or nearly or substantially exhausted. If the time period has expired or if the network congestion or resource exhaustion is determined, then a system returns processing to S1 and the anomaly profile for the remote sender may be erased, or the anomaly score represented in the profile diminished or decayed.

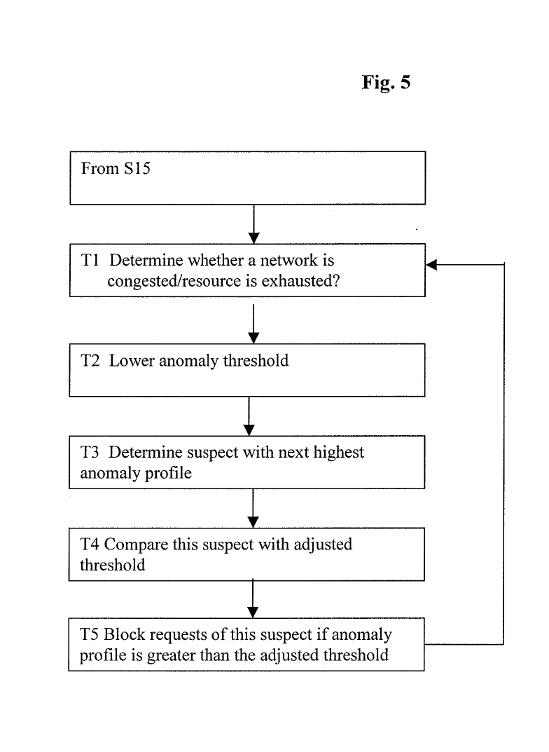

FIG. 5 illustrates an example of threshold throttling performed after a first suspect is determined and traffic from this first suspect have been blocked at S15 in FIG. 3B. At T1 in FIG. 5, it is determined whether the network is congested and/or one or more resources of the data center are exhausted or substantially exhausted. At T2, the threshold is lowered. At T3 the next suspect, which may be the suspect with the next highest anomaly profile, is determined, and at T4 the anomaly profile is compared with the adjusted threshold. If this anomaly profile exceeds the adjusted threshold, this suspect is blocked and processing continues to T1.

On the other hand, if the period has not timed out at S13 and if the network congestion/resource exhaustion is not determined at S14, then the remote sender is determined as a suspect, and appropriate action may be taken. At S16, the system administrator may be signaled, which may be a human user, and other action at S17 may be taken, such as signaling one or more components of the data center 50 to block all data requests received from the remote sender or to not respond to the remote sender, or the like.

Suspect determination engine 20 may be provided on one or more devices working in tandem, which may be any type of computer, cable of communicating with a second processor, including a “blade” provided on a rack, custom-designed hardware, a laptop, notebook, or other portable device. By way of illustrative example, an Apache webserver may be used running on LINUX. However, it will be understood that other systems may also be used.

An anomaly profile for a remote user may also be computed in other ways. For example, an anomaly representation may be assigned when a series of data packets in a communication stream have an overlapping range of byte counters, which generate an ambiguity due to different content in the overlapping range. Such overlapping ranges within packets may evidence an attempt to disguise an attack, and are unlikely to occur persistently for any given remote sender or data request source, especially if the communication is otherwise unimpaired.

The present methods, functions, systems, computer-readable medium product, or the like may be implemented using hardware, software, firmware or a combination of the foregoing, and may be implemented in one or more computer systems or other processing systems, such that no human operation may be necessary. That is, the methods and functions can be performed entirely automatically through machine operations, but need not be entirely performed by machines. A computer or computer systems including suspect determination engine 20 as described herein may include one or more processors in one or more units for performing the system according to the present disclosure, and these computers or processors may be located in a cloud or may be provided in a local enterprise setting or off premises at a third party contractor.

The communication interface may include a wired or wireless interface communicating over TCP/IP paradigm or other types of protocols, and may communicate via a wire, cable, fire optics, a telephone line, a cellular link, a radio frequency link, such as WI-FI or Bluetooth, a LAN, a WAN, VPN, or other such communication channels and networks, or via a combination of the foregoing.

Accordingly, a method, system, device and the means for providing such a method are described for providing improved protection against a resource exhaustion attack, such as a DDoS attack. An improved and more secure computer system is thus provided for. Accordingly, a computer system, such as a website, can thus be more robust, more secure and more protected against such an attack. In addition, because of the machine learning that may occur before deployment in the protection mode, a faster detection and an improved device response performance with fewer unnecessary computing resources may be achieved. That is, the machine and the computer system may respond faster and with less risk of shutting down a remote sender based on false positives and less risk of failure to determine a suspect. As a result of the faster and more accurate response, less energy may be consumed by the computer system in case of such an attack, and less wasteful heat may be generated and dissipated.

Although the present invention has been described in relation to particular embodiments thereof, many other variations and modifications and other uses will become apparent to those skilled in the art. Steps outlined in sequence need not necessarily be performed in sequence, not all steps need necessarily be executed and other intervening steps may be inserted. It is preferred, therefore, that the present invention be limited not by the specific disclosure herein.

What is claimed is:

1. A method of determining a first suspect in a resource exhaustion attack against a target automated processor communicatively connected to a data communication network, the method comprising:
monitoring a plurality of data processing requests received over the data communication network from a remote sender;
identifying a first transition, dependent on a first sequence of data processing requests comprising a first data processing request of the plurality of data processing requests and a second data processing request of the plurality of data processing requests;
determining, with an automated processor, a first anomaly profile for the remote sender based on a first anomaly representation assigned to the first transition and a second anomaly representation determined for the remote sender;
determining, with the automated processor, based on the first anomaly profile, that the remote sender is the first suspect in the resource exhaustion attack; and
based on the determining of the first suspect, taking action with the automated processor of at least one of: communicating a message dependent on the determining, and modifying at least one data processing request of the plurality of data processing requests.

2. The method of claim 1, further comprising identifying, as a second transition, a second sequence of data processing requests of the plurality of data processing requests for the remote sender,
wherein the second anomaly representation is an anomaly representation assigned to the second transition.

3. The method of claim 1, wherein the resource exhaustion attack is a distributed denial of service attack.

4. The method of claim 1, wherein the first anomaly representation and the second anomaly representation are anomaly values retrieved from a transition anomaly matrix in dependence on the first and second transitions, respectively, and the first anomaly profile for the remote sender is determined by combining the first anomaly representation and the second anomaly representation.

5. The method of claim 1, wherein the taking of the action is performed only after a resource use determination that at least one resource of the first automated processor is at least one of exhausted or substantially exhausted.

6. The method of claim 1, further comprising:
monitoring a period of time between a time of the first transition and a time of the determination of the second anomaly representation,
wherein the taking of the action is performed only when the period of time is shorter than a predetermined period of time.

7. The method of claim 1, further comprising comparing the first anomaly profile with a first threshold,
wherein the remote sender is determined as the first suspect only when the first anomaly profile is greater than the first threshold.

8. The method of claim 7, further comprising:
after the first suspect is determined, when at least one resource of the first automated processor is at least one of exhausted or substantially exhausted, adjusting the threshold; and
determining a second suspect with a second anomaly profile by comparing the second anomaly profile with the adjusted threshold.

9. The method of claim 1, further comprising assigning the second anomaly representation based on an overlapping range in packets received from the remote sender.

10. The method of claim 1, wherein the automated processor is positioned at a web server, the data communication network is the Internet, and each data processing request of the plurality of data processing requests comprises a request for a webpage.

11. The method of claim 1, wherein the taking the action comprises sending a signal to diminish a response to data processing requests of the first suspect.

12. The method of claim 1, further comprising:
obtaining a plurality of sampling data processing requests received over the data communication network from a plurality of remote senders;
identifying, as a first sampling transition, a first sequence of data processing requests comprising a first sampling data processing request of the plurality of sampling data processing requests and a second sampling data processing request of the plurality of data processing requests;
identifying, as a second sampling transition, a second sequence of data processing requests comprising the second data processing request and a third data processing request of the plurality of sampling data processing requests; and
assigning the first anomaly representation to the first sampling transition as a function of a frequency of the first sampling transition, and assigning the second anomaly representation to the second transition, as a function of a frequency of the second sampling transition.

13. The method of claim 12, wherein the frequency of the first transition and the frequency of the second transition are calculated based on the frequency over a period of time of the first sampling transition and the second sampling transition with respect to a totality of the plurality of sampling data processing requests obtained.

14. A computing device comprising an automated processor for determining a first suspect in a resource exhaustion attack against a target automated processor connected to a data communication network, the computing device comprising:
a network interface configured to monitor a plurality of data processing requests received over the data communication network from a remote sender;
a transition identifier configured to identify, as a first transition, a first sequence of data processing requests comprising a first data processing request of the plurality of data processing requests and a second data processing request of the plurality of data processing requests;
an anomaly profiler configured to determine a first anomaly profile for the remote sender based on a first anomaly representation assigned to the first transition and a second anomaly representation determined for the remote sender;
a suspect determiner configured to determine, based on the first anomaly profile, and an anomaly threshold, that the remote sender is the first suspect in the resource exhaustion attack; and
a suspect response generator configured to take action, when the first suspect is determined, of at least one of: communicating a message in dependence on the determination of the first suspect, and modifying at least one data processing request of the plurality of data processing requests.

15. The computing device according to claim 14, further comprising a web server comprising the target automated processor.

16. The computing device of claim 14, wherein the transition identifier is configured to identify a second transition, the second transition being a second sequence of data processing requests of the plurality of data processing requests for the remote sender,
wherein the second anomaly representation is an anomaly representation assigned to the second transition.

17. The computing device of claim 14, wherein the resource exhaustion attack is a distributed denial of service attack and the data communication network is the Internet.

18. The computing device of claim 14, further comprising:
a transition anomaly processor configured to retrieve anomaly values corresponding to the first anomaly representation and the second anomaly representation,
wherein the first anomaly profile for the remote sender is determined by combining the first anomaly representation and the second anomaly representation.

19. The computing device of claim 14, wherein the taking of the action is performed only after a resource use determination that at least one resource of the target automated processor is at least one of exhausted or substantially exhausted.

20. The computing device of claim 14, further comprising:
a timer configured to monitor a period of time between a time of the first transition and a time of the determination of the second anomaly representation; and
an anomaly threshold processor configured to compare the first anomaly profile with a first threshold,
wherein the taking of the action is performed only when the period of time is shorter than a predetermined period of time and the first anomaly profile is greater than the first threshold.

21. The computing device of claim 20, further comprising a threshold manager configured to adjust the threshold after the first suspect is determined, only when at least one resource of the first automated processor is at least one of exhausted or substantially exhausted; and
the suspect determiner is configured to determine a second suspect with a second anomaly profile by comparing the second anomaly profile with the adjusted threshold.

22. The computing device of claim 14, wherein the anomaly profiler is configured to assign the second anomaly representation based on an overlapping range in sender fields of packets received from the remote sender.

23. The computing device of claim 14, wherein the suspect response generator is further configured to take the action comprising sending a signal to a device to intercept data processing requests of the first suspect.

24. The computing device of claim 14, further comprising:
a transition identifier configured to obtain a plurality of sampling data processing requests received over the data communication network from a plurality of remote senders, and to identify, as a first sampling transition, a first sequence of data processing requests comprising a first sampling data processing request of the plurality of sampling data processing requests and a second sampling data processing request of the plurality of data processing requests;
the transition identifier configured to identify, as a second sampling transition, a second sequence of data processing requests comprising the second data processing request and a third data processing request of the plurality of sampling data processing requests; and
an anomaly assigner configured to assign the first anomaly representation to the first sampling transition as a function of a frequency of the first sampling transition, and to assign the second anomaly representation to the second transition, as a function of a frequency of the second sampling transition.

25. The computing device of claim 24, wherein the anomaly assigner is configured to calculate the frequency of the first transition and the frequency of the second transition based on the frequency over a period of time of the first sampling transition and the second sampling transition with respect to a totality of the plurality of sampling data processing requests obtained.

26. The computing device of claim 14, further comprising:
the network interface configured to monitor a second plurality of data processing requests received over the data communication network from a second remote sender;
the transition identifier configured to identify, as a first transition of the second remote sender, a first sequence of data processing requests from the second remote sender comprising a first data processing request of the second plurality of data processing requests and a second data processing request of the second plurality of data processing requests;
the transition identifier configured to identify a similarity between the first transition of the first remote sender and the first transition of the second remote sender; and
the anomaly profiler configured to determine a second anomaly profile for the second remote sender based on the similarity; and
the suspect determiner configured to determine, based on the second anomaly profile and the anomaly threshold, that the remote sender is a second suspect in the resource exhaustion attack.

27. The computing device of claim 14, further comprising:
the network interface configured to monitor a second plurality of data processing requests received over the data communication network from a second remote sender;
the transition identifier configured to identify, as a first transition of the second remote sender, a first sequence of data processing requests from the second remote sender comprising a first data processing request of the second plurality of data processing requests and a second data processing request of the second plurality of data processing requests;
the transition identifier configured to identify a similarity between the first transition of the first remote sender and the first transition of the second remote sender;
the anomaly profiler configured to determine, based on the similarity, an aggregated anomaly profile for the first and second remote senders; and
the suspect determiner configured to determine, based on the aggregated anomaly profile and the anomaly threshold, that the first and second remote senders are suspects in the resource exhaustion attack.
